(19) United States
(12) Patent Application Publication
(10) Pub. No.: US 2007/0263155 A1
(43) Pub. Date: Nov. 15, 2007

(54) Plasma display panel and method of driving the same

(75) Inventors: Jong Mun Yang, Gumi-si (KR); Dooyong Hwang, Yongin-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/634,122

(22) Filed: Dec. 6, 2006

(30) Foreign Application Priority Data
May 15, 2006 (KR) 10-2006-0043605

(51) Int. Cl. G02F 1/1343; G02F 1/1333

(52) U.S. Cl. 349/143; 349/158

(57) ABSTRACT

A plasma display panel and a method of driving the same are disclosed. The plasma display panel includes a first area where an image is displayed and a second area where the image is not displayed, and a plurality of electrodes formed in the first area and the second area. At least one of the plurality of electrodes has a first bending point and a second bending point in the second area. A distance between the first bending points is different from a distance between the second bending points in the second area. A protective layer, barrier ribs, and a dielectric layer included in the plasma display panel have a Pb content equal to or less than 1,000 PPM (parts per million).

This Nonprovisional application claims priority under 35 U.S.C. §119(a) on Patent Application No. 10-2006-0043605 filed in Korea on May 15, 2006 the entire contents of which are hereby incorporated by reference.

### FIELD

This document relates to a plasma display panel and a method of driving the same.

### BACKGROUND

In General, a plasma display panel includes a phosphor layer formed inside a discharge cell partitioned by barrier ribs and a plurality of electrodes.

A driving signal is supplied to the discharge cell through the plurality of electrodes.

When a discharge occurs by a high frequency voltage supplied to the discharge cell, a discharge gas filled in the discharge cell generates vacuum ultra-violet rays, which thereby cause phosphors formed between the barrier ribs to emit light, thus generating visible light.

An image is displayed on a screen of the plasma display panel due to visible light.

FIGS. 1a and 1b illustrate a related art plasma display panel.

As illustrated in FIG. 1a, the related art plasma display panel 100 includes an electrode, for example, a scan electrode Y.

The scan electrode Y is connected to an external driver 110. The external driver 110 supplies a driving signal to the scan electrode Y.

For example, the driver 110 supplies a driving signal to a scan electrode Y1, a scan electrode Y2, . . . , a scan electrode Ya, . . . , a scan electrode Yb−1, and a scan electrode Yb.

As illustrated in FIG. 1b, the plurality of scan electrodes Y bend at a predetermined angle at a connection point of the driver 110 and the scan electrode Y and are formed in one side direction. The plurality of scan electrodes Y are disposed in parallel.

When the plurality of scan electrodes Y are disposed as illustrated in FIG. 1b, an electrical short-circuit occurs between the scan electrodes Y at bending points 130 and 140 of the scan electrodes Y.

For example, the electrical short-circuit may occur between the scan electrodes Y1, Y2 and Y3 at the bending point 130. The electrical short-circuit may occur between the scan electrodes Yb−2, Yb−1 and Yb at the bending point 140.

In a general aspect, a plasma display panel comprising a first substrate, a dielectric layer formed on the first substrate, a protective layer formed on the dielectric layer, a second substrate facing the first substrate, and barrier ribs between the first and second substrates, the plasma display panel comprises a first area where an image is displayed and a second area where the image is not displayed, and a plurality of electrodes formed in the first area and the second area, wherein at least one of the plurality of electrodes has a first bending point and a second bending point in the second area and has a distance between the first bending points being different from a distance between the second bending points in the second area, wherein the protective layer, the barrier ribs, and the dielectric layer have a Pb content equal to or less than 1,000 PPM (parts per million).

In another aspect, a plasma display panel comprising a first substrate, a dielectric layer formed on the first substrate, a protective layer formed on the dielectric layer, a second substrate facing the first substrate and barrier ribs between the first and second substrates, the plasma display panel comprises a first area where an image is displayed and a second area where the image is not displayed, and a plurality of electrodes formed in the first area and the second area, wherein at least one of the plurality of electrodes has a first bent portion and a second bent portion in the second area and has a distance between the first bent portions gradually increases, and a distance between the second bent portions is substantially constant or gradually decreases, wherein the protective layer, the barrier ribs and the dielectric layer have a Pb content being equal to or less than 1,000 PPM.

In still another aspect, in a plasma display panel comprising a substrate, a plurality of electrodes formed on the substrate, a protective layer and a dielectric layer, wherein a Pb content of at least one of the protective layer or the dielectric layer is equal to or less than 1,000 PPM, the substrate comprises a first area where an image is displayed and a second area where the image is not displayed, the plurality of electrodes are formed in the first area and the second area, at least one electrode of the plurality of electrodes comprises a first portion, a second portion and a third portion, the first portion is formed in the first area and the second area such that the first portion in the first area is formed to extend in a first direction toward the second portion in the second area, the second portion is formed in the second area in a second direction different from the first direction such that a first angle is formed between the first direction and the second direction and extending in the second direction from the first portion toward the third portion, and the third portion is formed in the second area in a third direction different from the first direction and the second direction such that a second angle is formed between the first direction and the third direction.

Further features will be apparent from the following description, including the drawings, and the claims.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIGS. 1a and 1b illustrate a related art plasma display panel;

FIGS. 2a and 2b illustrate the structure of a plasma display panel according to an embodiment;

FIG. 3 illustrates the structure of an electrode of the plasma display panel;

FIG. 4 illustrates the structure of an electrode in a second area;

FIG. 5 illustrates the configuration in which a first electrode, a second electrode and a black layer are formed on a substrate;

FIGS. 6a to 6c illustrate the disposition of electrodes in the plasma display panel depending on a driver;

FIG. 7 illustrates the structure of the electrode at different bending points;

FIG. 8 illustrates the structure of electrodes in which the length of a second portion and a first angle of an electrode are different from the length of a second portion and a first angle of another electrode;

FIG. 9 illustrates the structure of the electrode further comprising another portion;

FIG. 10 illustrates the structure of the electrode formed in a different direction;

FIG. 11 illustrates the structure in which a plurality of pairs of scan electrodes and a plurality of pairs of sustain electrodes are successively disposed;

FIGS. 12a and 12b illustrate a black layer and the structure of the electrodes in which two scan electrodes and two sustain electrodes are successively disposed in a first area and a second area of a substrate;

FIG. 13 illustrates the structure of the electrodes in a first area of the substrate of the plasma display panel;

FIGS. 14a and 14b illustrate another structure of a projecting portion;

FIG. 15 illustrates an example of a driving signal supplied to the plasma display panel; and

FIGS. 16a to 16d illustrate a method for supplying different reset signals in subfields.

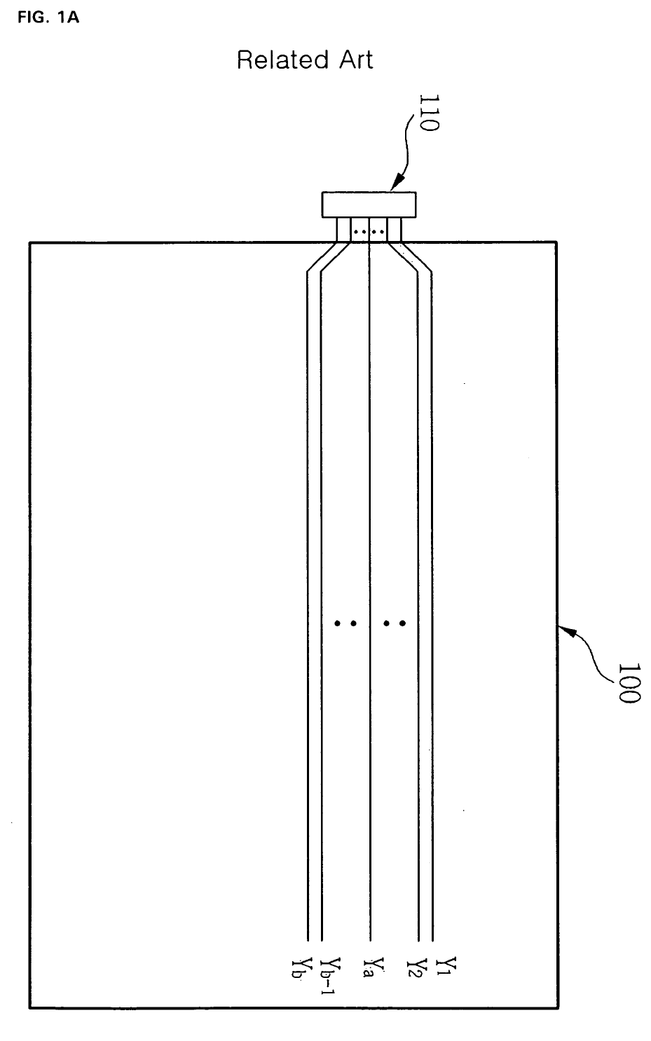

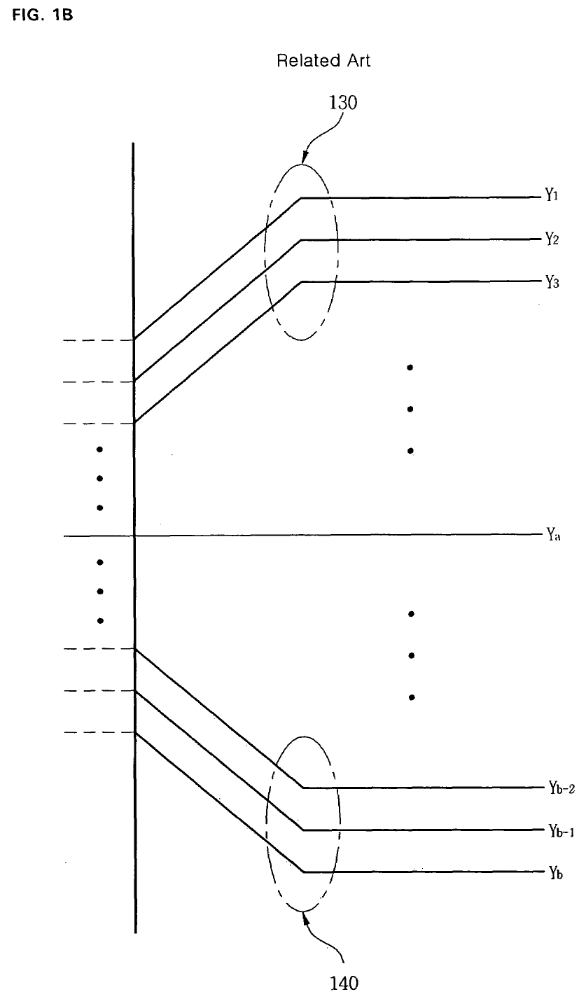

### DETAILED DESCRIPTION OF PREFERRED EMBODIMENTS

A plasma display panel and a method of driving the same will now be described in detail with reference to the accompanying drawings.

A plasma display panel comprising a first substrate, a dielectric layer formed on the first substrate, a protective layer formed on the dielectric layer, a second substrate facing the first substrate, and barrier ribs between the first and second substrates, the plasma display panel comprises a first area where an image is displayed and a second area where the image is not displayed, and a plurality of electrodes formed in the first area and the second area, wherein at least one of the plurality of electrodes has a first bending point and a second bending point in the second area and has a distance between the first bending points being different from a distance between the second bending points in the second area, wherein the protective layer, the barrier ribs, and the dielectric layer have a Pb content equal to or less than 1,000 PPM (parts per million).

The distance between the second bending points of the at least one of the plurality of electrodes in the second area may be longer than the distance between the distance between the at least one of the plurality of electrodes in the first area.

The at least one of plurality of electrodes may have a third bending point in the second area.

The plurality of electrodes each may comprise transparent electrodes.

A plasma display panel comprising a first substrate, a dielectric layer formed on the first substrate, a protective layer formed on the dielectric layer, a second substrate facing the first substrate and barrier ribs between the first and second substrates, the plasma display panel comprises a first area where an image is displayed and a second area where the image is not displayed, and a plurality of electrodes formed in the first area and the second area, wherein at least one of the plurality of electrodes has a first bent portion and a second bent portion in the second area and has a distance between the first bent portions gradually increases, and a distance between the second bent portions is substantially constant or gradually decreases, wherein the protective layer, the barrier ribs and the dielectric layer have a Pb content being equal to or less than 1,000 PPM.

The at least one of the plurality of electrodes may comprise a third bent portion in the second area, and a distance between the third bent portions may be substantially constant.

The distance between the second bent portions in the at least one of the plurality of electrodes may be more than a distance between the electrodes in the at least one of the plurality of electrodes in the first area.

A ratio of the distance between the electrodes in the at least one of the plurality of electrodes in the first area to the distance between the second bent portions in the at least one of the plurality of electrodes may range from 1:3 to 1:8.

A ratio of a section width of the at least one of the plurality of electrodes in the first area to a section width of the first bent portions in the at least one of the plurality of electrodes may range from 1:1.5 to 1:2.5.

A ratio of a section width of each electrode in the at least one of the plurality of electrodes in the first area to a section width of the second bent portions in the at least one of the plurality of electrodes may range from 1:1.5 to 1:2.5.

In a plasma display panel comprising a substrate, a plurality of electrodes formed on the substrate, a protective layer and a dielectric layer, wherein a Pb content of at least one of the protective layer or the dielectric layer is equal to or less than 1,000 PPM, the substrate comprises a first area where an image is displayed and a second area where the image is not displayed, the plurality of electrodes are formed in the first area and the second area, at least one electrode of the plurality of electrodes comprises a first portion, a second portion and a third portion, the first portion is formed in the first area and the second area such that the first portion in the first area is formed to extend in a first direction toward the second portion in the second area, the second portion is formed in the second area in a second direction different from the first direction such that a first angle is formed between the first direction and the second direction and extending in the second direction from the first portion toward the third portion, and the third portion is formed in the second area in a third direction different from the first direction and the second direction such that a second angle is formed between the first direction and the third direction.

The plurality of electrodes may comprise a plurality of pairs of electrodes wherein a distance between the electrodes in each electrode pair is less than a distance between each of the pairs of electrodes. The first angle may be formed such that a distance between the second portions in the electrode pair gradually increases, and the second angle may be formed so that a distance between the third portions in the electrode pair is substantially constant or gradually decreases.

At least one electrode of the plurality of electrodes may comprise a fourth portion in the second area, and the fourth portion may be formed in a direction substantially equal to the first direction.

At least one electrode of the plurality of electrodes may comprise a first electrode in the second area. The first electrode may be formed between the substrate and a black layer having a width that is substantially equal to or less than a width of the first electrode.

At least one electrode of the plurality of electrodes may comprise the first electrode and a second electrode in the second area. The black layer may be formed between the first electrode and the second electrode. A width of the black layer may be substantially equal to a width of the second electrode.

The first electrode may be formed of a transparent material with the electrical conductivity, and the second electrode may be formed of an opaque material with the electrical conductivity.

A length of the first portion in the second area of at least one electrode of the plurality of electrodes may be different from a length of a first portion in the second area, of at least one electrode of the remaining electrodes except at least one electrode of the plurality of electrodes.

A length of the second portion of at least one electrode of the plurality of electrodes may be different from a length of a second portion of at least one electrode of the remaining electrodes except at least one electrode of the plurality of electrodes.

The first angle of at least one electrode of the plurality of electrodes may be different from a first angle of at least one electrode of the remaining electrodes except at least one electrode of the plurality of electrodes.

The plurality of electrodes each may comprise a plurality of scan electrode pairs and a plurality of sustain electrode pairs disposed in parallel to each other. A distance between the electrodes in each scan electrode pair and a distance between the electrodes in each sustain electrode pair may be less than a distance between the scan electrode pair and the sustain electrode pair.

Hereinafter, exemplary implementations will be described in detail with reference to the attached drawings.

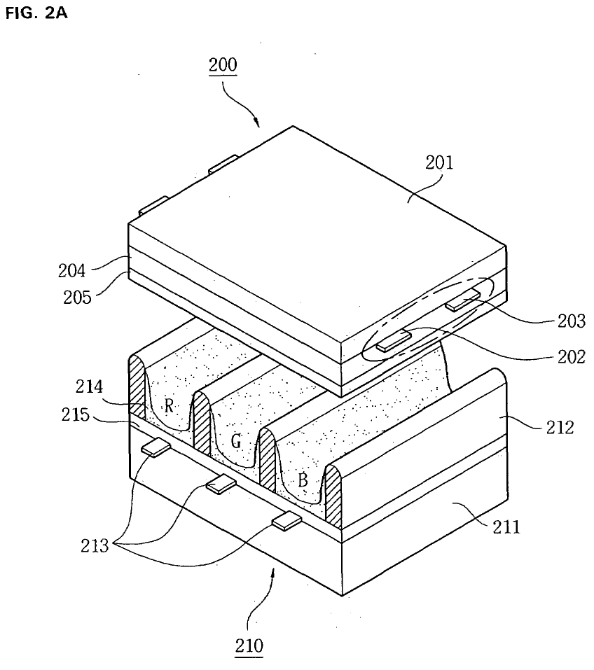

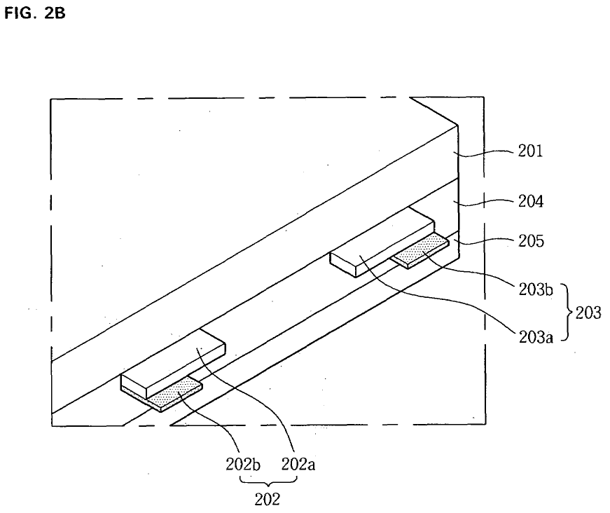

FIGS. 2a and 2b illustrate the structure of a plasma display panel.

Referring to FIG. 2a, the plasma display panel comprises a front panel 200 and a rear panel 210 coalesced to each other. The front panel 200 comprises a front substrate 201 on which a scan electrode 202 and a sustain electrodes 203 are formed. The rear panel 210 comprises a rear substrate 211 on which an address electrode 213 is formed to intersect with the scan electrode 202 and the sustain electrodes 203.

A discharge of a discharge cell occurs through the scan electrode 202 and the sustain electrodes 203. A driving signal for maintaining the discharge of the discharge cell is supplied to the scan electrode 202 and the sustain electrodes 203.

An upper dielectric layer 204 is formed on an upper part of the front substrate 201, on which the scan electrode 202 and the sustain electrodes 203 are formed, to cover the scan electrode 202 and the sustain electrodes 203.

The upper dielectric layer 204 limits a discharge current of the scan electrode 202 and the sustain electrodes 203 and provides insulation between the scan electrode 202 and the sustain electrodes 203.

A protective layer 205 is formed on an upper surface of the upper dielectric layer 204 to facilitate discharge conditions. The protective layer 205 may be formed by depositing a material such as MgO on the upper surface of the upper dielectric layer 204.

The address electrode 213 formed on the rear substrate 211 is used to supply a data signal to the discharge cell.

A lower dielectric layer 215 is formed on an upper part of the rear substrate 211, on which the address electrode 213 is formed, to cover the address electrode 213. The lower dielectric layer 215 provides insulation of the address electrode 213.

A stripe-type or well-type barrier rib 212 is formed on an upper part of the lower dielectric layer 215 to form a discharge space (i.e., a discharge cell). Accordingly, a red (R) discharge cell, a green (G) discharge cell or a blue (B) discharge cell are formed between the front substrate 201 and the rear substrate 211.

The discharge cell partitioned by the barrier rib 212 is filled with a predetermined discharge gas.

A phosphor layer 214 for emitting visible light for an image display when generating a discharge is formed inside the discharge cell partitioned by the barrier rib 212. For example, a red (R) phosphor layer, a green (G) phosphor layer or a blue (B) phosphor layer may be formed.

A driving signal is supplied to at least one of the scan electrode 202, the sustain electrode 203 or the address electrode 213 of the plasma display panel with the above-described structure such that the discharge occurs inside the discharge cell partitioned by the barrier rib 212.

The discharge gas filled in the discharge cell generates vacuum ultraviolet rays. The vacuum ultraviolet rays is applied to the phosphor layer 214 formed inside the discharge cell.

The vacuum ultraviolet rays generate visible light in the phosphor layer 214. The visible light is emitted to the outside through the front substrate 201, on which the upper dielectric layer 204 is formed, and thus displaying an image an external surface of the front substrate 201.

At least one of the scan electrode 202, the sustain electrode 203 or the address electrode 213 may include a plurality of layers.

As illustrated in FIG. 2b, the scan electrode 202 and the sustain electrode 203 each include a plurality of layers. For example, the scan electrode 202 and the sustain electrode 203 each include first electrodes 202a and 203a and second electrodes 202b and 203b.

Although the explanation was given of an example where the scan electrode 202 and the sustain electrode 203 each include the first electrodes 202a and 203a and the second electrodes 202b and 203b in FIG. 2b, the address electrode 213 may include a first electrode and a second electrode.

Light transmissivity and electrical conductivity of the first electrodes 202a and 203a and the second electrodes 202b and 203b need to be considered to emit light generated within the discharge cell to the outside and to secure driving efficiency. Accordingly, the first electrodes 202a and 203a of the scan electrode 202 and the sustain electrode 203 may be formed of a transparent material. The second electrodes 202b and 203b of the scan electrode 202 and the sustain electrode 203 may be formed of an opaque material with electrical conductivity.

For example, the first electrodes 202a and 203a may be formed of a transparent material such as indium-tin-oxide (ITO) material. The second electrodes 202b and 203b may be formed of an opaque material with electrical conductivity such as Ag.

Since the first electrodes 202a and 203a of the scan electrode 202 and the sustain electrode 203 are formed of the transparent material, visible light generated inside the discharge cell is efficiently emitted to the outside of the plasma display panel.

Since the second electrodes 202b and 203b of the scan electrode 202 and the sustain electrode 203 are formed of the opaque material with the electrical conductivity, the second electrodes 202b and 203b prevent a reduction in the driving efficiency caused by the first electrodes 202a and 203a with low electrical conductivity. In other words, the second electrodes 202b and 203b compensate the low electrical conductivity of the first electrodes 202a and 203a.

The width of the scan electrode 202 and the width of the sustain electrode 203 each may range from 70 μm to 250 μm. When the width of the scan electrode 202 and the width of the sustain electrode 203 are within the above range, it is easy to fabricate the scan electrode 202 and the sustain electrode 203 and the prevention of short-circuit and an increase in energy efficiency are effective.

When a Pb content of the scan electrode 202 and the sustain electrode 203 is equal to or less than 1,000 PPM (parts per million) and the width of each of the scan electrode 202 and the sustain electrode 203 ranges from 70 μm to 250 μm, the driving efficiency of the plasma display panel is improved and malfunction decreases.

Only an example of the plasma display panel was illustrated in FIGS. 2a and 2b. Therefore, the plasma display panel is not limited to the structure of the plasma display panel illustrated in FIGS. 2a and 2b.

For example, the upper dielectric layer 204 and the lower dielectric layer 215 each are formed in the form of a single layer in the plasma display panel of FIGS. 2a and 2b. However, at least one of,the upper dielectric layer 204 and the lower dielectric layer 215 may comprise a plurality of layers.

A black layer (not shown) for absorbing external light may be formed on the barrier rib 212 to prevent reflection of the external light caused by the barrier rib 212.

A Pb content of at least one of the scan electrode 202, the sustain electrode 203, the address electrode 213, the dielectric layers 204 and 215, the barrier rib 212, the phosphor layer 214, the protective layer 205 or a seal material may be equal to or less than 1,000 PPM.

The seal material is located at an edge of the plasma display panel and is used to coalesce the front substrate and the rear substrate.

The Pb content, based on all components of the plasma display panel 100, may be equal to or less than 1,000 PPM.

When the plasma display panel 100 includes a large amount of Pb more than 1,000 PPM, the large amount of Pb can adversely affect the body.

A reduction in the Pb content of the plasma display panel 100 may vary a panel capacitance. A change in the panel capacitance may occur an erroneous discharge. Accordingly, the width of the electrode, a shape of the electrode, a waveform, and the like, in the plasma display panel can prevent the erroneous discharge.

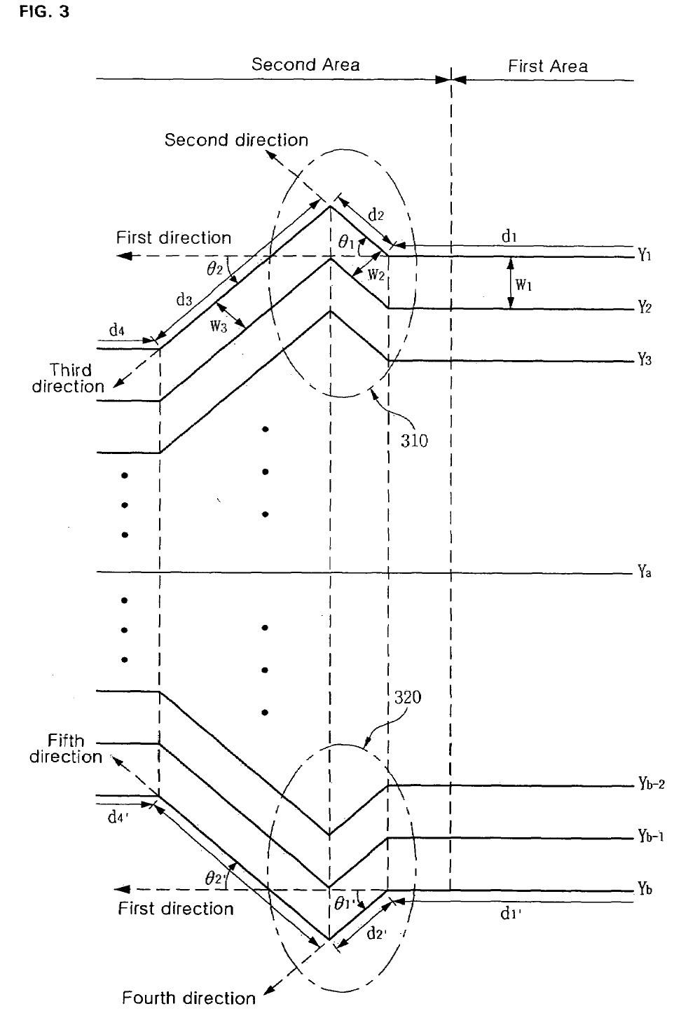

FIG. 3 illustrates the structure of an electrode of the plasma display panel.

As illustrated in FIG. 3, the plasma display panel comprises a first area where an image is displayed and a second area where an image is not displayed. A plurality of electrodes on a substrate are formed on the first area and the second area. At least one of the plurality of electrodes comprises a first portion d1, a second portion d2 and a third portion d3.

For example, an Y1 electrode, an Y2 electrode and an Y3 electrode of the plurality of electrodes each may comprise the first portion d1, the second portion d2 and the third portion d3. The first portion d1 is formed in the first area and the second area such that the first portion d1 in the first area is formed to extend in a first direction toward the second portion d2 in the second area. The second portion d2 is formed in the second area in a second direction different from the first direction such that a first angle θ1 is formed between the first direction and the second direction and extending in the second direction from the first portion d1 toward the third portion d3. The third portion d3 is formed in the second area in a third direction different from the first direction and the second direction such that a second angle θ2 is formed between the first direction and the third direction.

Further, an Yb−2 electrode, an Yb−1 electrode and an Yb electrode of the plurality of electrodes each may comprise a first portion d1′, a second portion d2′ and a third portion d3′. The first portion d1′ is formed on the first area and the second area so that the first portion d1′ in the first area is formed in the first direction toward the second portion d2′ in the second area. The second portion d2′ is formed in the second area in a fourth direction different from the first direction such that a first angle θ1′ is formed between the first direction and the fourth direction and extending in a fourth direction from the first portion toward the third portion d3′.

The second portion d2′ is formed on the second area in a fourth direction different the first direction so that an angle between the first direction and the fourth direction is equal to a first angle θ1′. The third portion d3′ is formed in the second area in a fifth direction different from the first direction and the fourth direction such that a second angle θ2′ is formed between the first direction d1 and the third direction d3.

In the plurality of electrodes formed on the first area and the second area of the substrate, the first angles θ1 and θ1′ are different from the second angles θ2 and θ2′ such that the second direction and the fourth direction are different from the third direction and the fifth direction.

Unlike FIG. 3, when the Y2 electrode is formed closer to the Y1 electrode than the Y3 electrode in the first area, the first angle in the second area may be formed so that a distance W2 between the second portions of the two adjacent Y1 and Y2 electrodes gradually may widen, and the second angle of the second area may be formed so that a distance W3 between the third portions of the two adjacent Y1 and Y2 electrodes gradually may decrease.

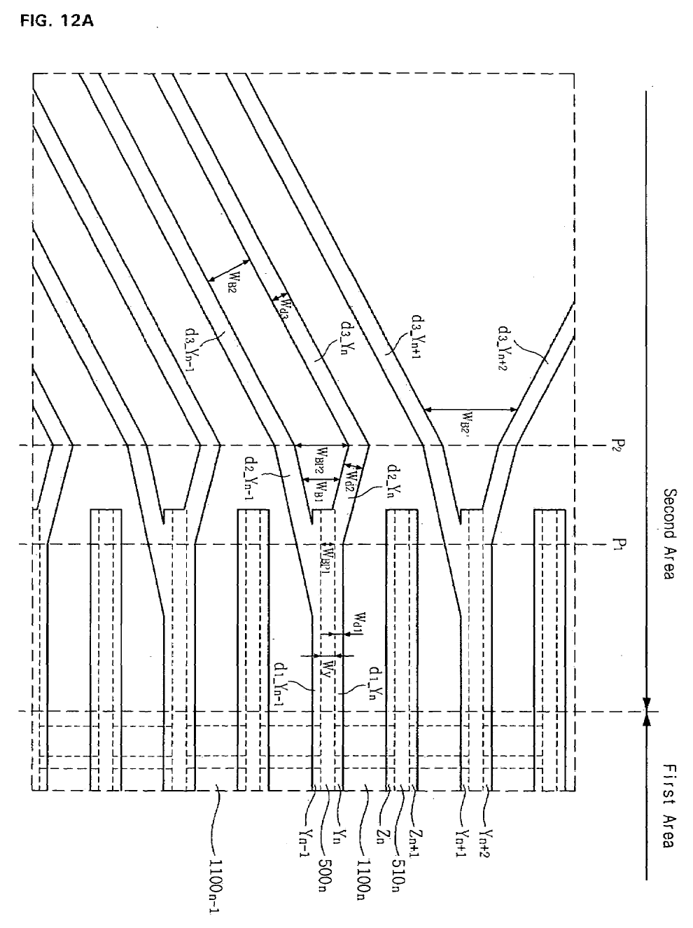

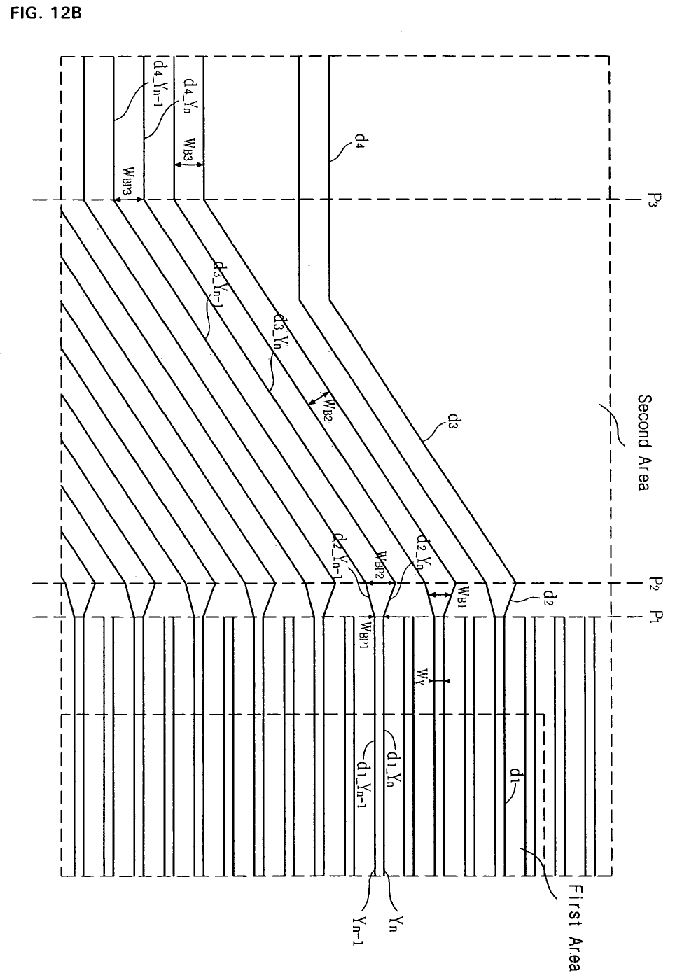

The distance W2 between the second portions and the distance W3 between the third portions in the two adjacent Y1 and Y2 electrodes of the plurality of electrodes may be more than a distance W1 between the two adjacent Y1 and Y2 electrodes in the first area. This will be described in detail later with reference to FIG. 12.

At bending points 310 and 320 of the electrodes, the distance between the plurality of electrodes can be sufficiently secured. Accordingly, an electrical short-circuit between the electrodes is prevented.

At least one of the plurality of electrodes may further comprise fourth portions d4 and d4′ in the second area.

The fourth portions d4 and d4′ is formed in a direction substantially equal to the first direction.

Accordingly, it is easy to connect electrode lines of a driver for supplying a driving signal to the plasma display panel to electrodes lines formed on the substrate of the plasma display panel.

Although the explanation was given of an example of the Y electrode (i.e., scan electrode) of the plurality electrodes of the plasma display panel in FIG. 3, the sustain electrode Z and the address electrode X may be formed in the same manner as the scan electrode.

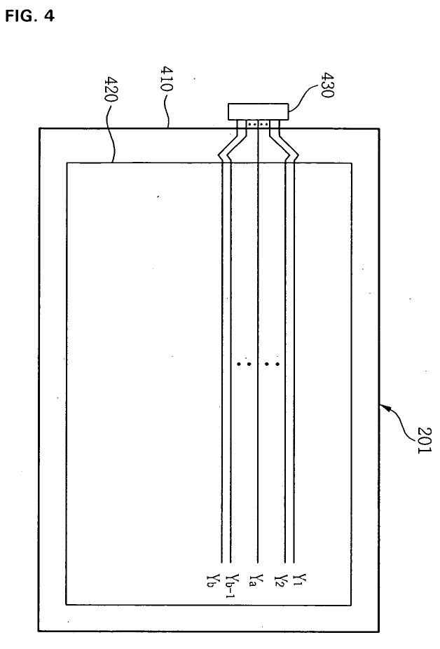

FIG. 4 illustrates the structure of an electrode in a second area.

As illustrated in FIG. 4, the substrate 201 of the plasma display substrate comprises a first area 420 where an image is displayed and a second area 410 where an image is not displayed.

The first area 420 substantially contributes to an image display. The second area 410 contributes to connect a driver 430 to the electrode (for example, the scan electrode) except an image display.

In the second area 410, at least one of the scan electrodes Y, as illustrated in FIG. 3, comprises a first portion, a second portion and a third portion. The scan electrode is formed so that the first portion goes toward the first direction, the second portion goes toward the second direction, and the third portion goes toward the third direction.

The second area, as illustrated in FIG. 3, comprises a portion of the first portion d1, the second portion d2 and the third portion d3.

When at least one of the scan electrodes in the second area 410 comprises the first portion, the second portion and the third portion, the electrical short-circuit between the scan electrodes is prevented and the connection of the scan electrode and the driver 430 is easy.

The plurality of electrodes in the second area 410 may comprise either a first electrode formed of a transparent material with electrical conductivity or a second electrode formed of an opaque material with electrical conductivity.

When the plurality of electrodes in the second area 410 comprise only the first electrode, the first electrode may be disposed between the substrate 201 and the black layer. A width of the black layer may be equal to or less than a width of the first electrode.

When the plurality of electrodes comprise the first electrode and the second electrode, the black layer may be formed between the first electrode and the second electrode and a width of the black layer may be substantially equal to a width of the second electrode.

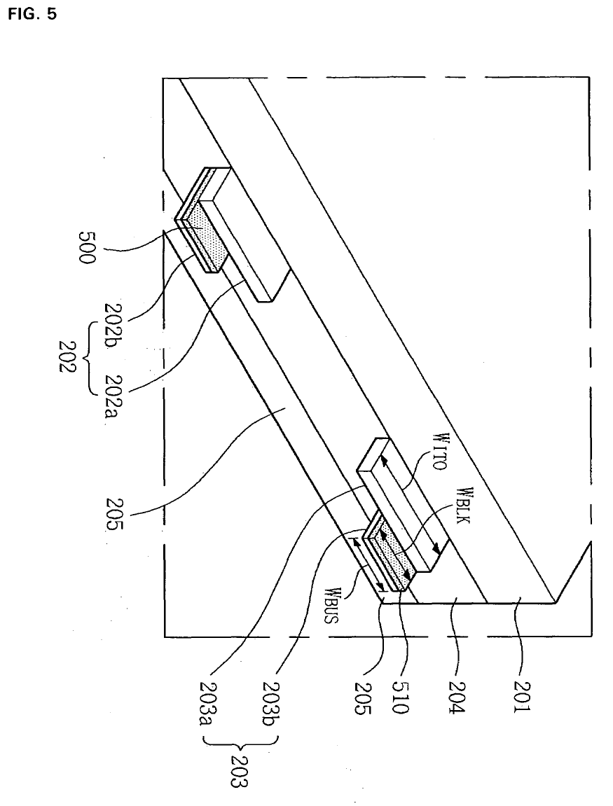

The configuration, in which the plurality of electrodes comprise the first electrode and the second electrode and the black layer is formed between the first electrode and the second electrode, will be described in detail with reference to FIG. 5.

FIG. 5 illustrates the configuration in which a first electrode, a second electrode and a black layer are formed on a substrate.

As illustrated in FIG. 5, the first electrodes 202a and 203a are formed on the substrate 201, black layers 500 and 510 are formed on the first electrodes 202a and 203a, and the second electrodes 202b and 203b are formed on the black layers 500 and 510.

At least one of the black layer 500 or 510 may comprise a first portion, a second portion and a third portion in the second area of the substrate 201.

A width W_{ITO} of the first electrode may be more than a width W_{BUS} of the second electrode and a width W_{BLK} of the black layer. The width W_{BUS} of the second electrode may be substantially equal to the width W_{BLK} of the black layer.

A shape of at least one of the black layer 500 or 510 is approximately the same as a shape of the scan electrode Y or a shape of the sustain electrode Z.

The disposition of the electrodes in the plasma display panel may depend on the driver.

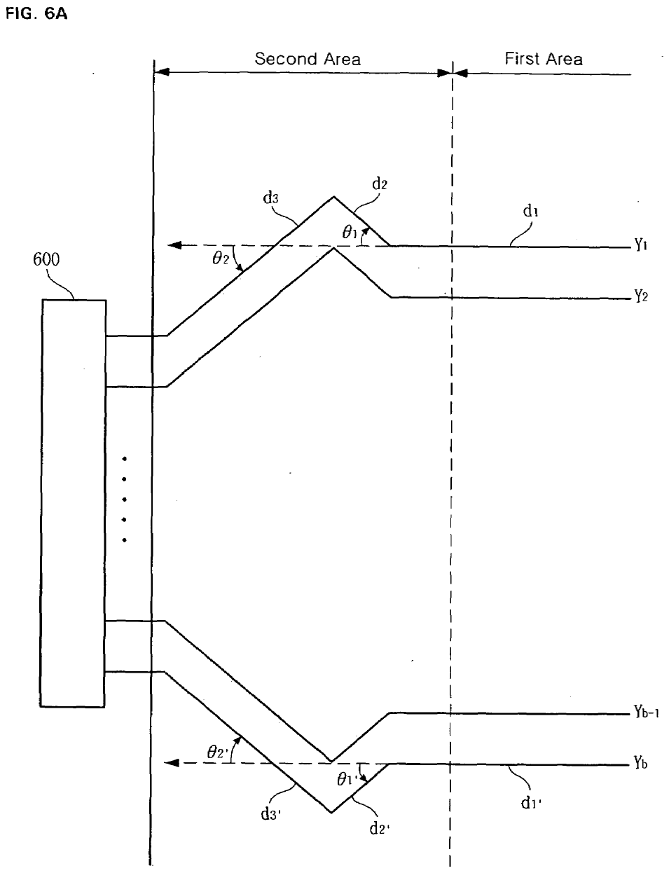

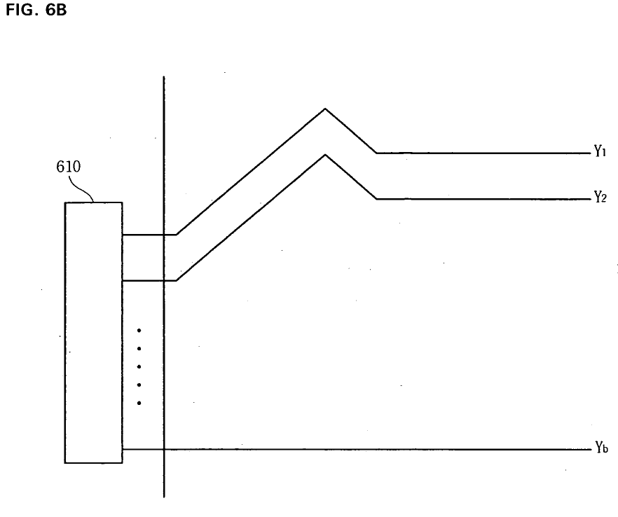

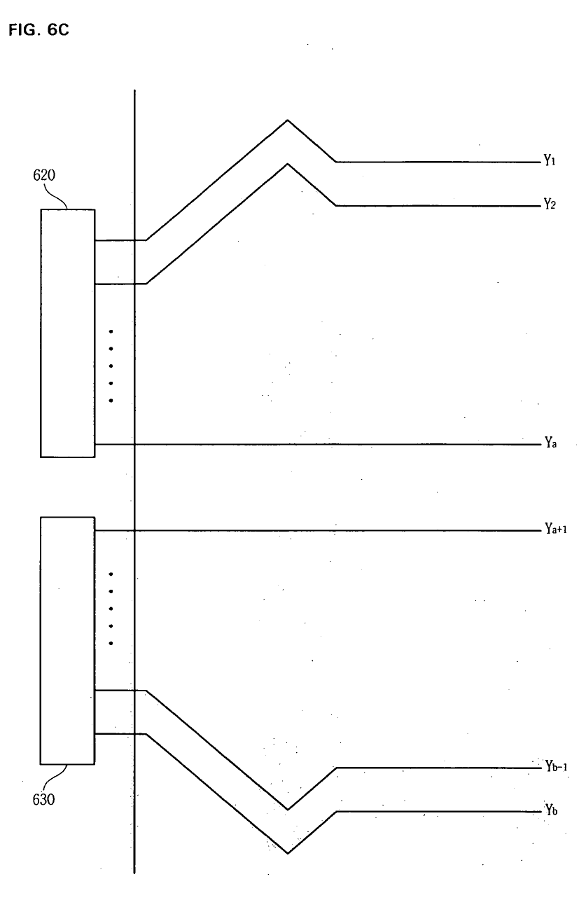

FIGS. 6a to 6c illustrate the disposition of electrodes in the plasma display panel depending on a driver.

Below, the explanation will be given of an example of the scan electrode Y of the plurality of electrodes of the plasma display panel in FIGS. 6a to 6c.

As illustrated in FIG. 6a, at least one (for example, the Y1 and Y2 electrodes) of the plurality of scan electrodes connected to a driver 600 comprises a first portion d1, a second portion d2 and a third portion d3. The first portion d1 is formed in the first direction in the first area. The second portion d2 is formed in the second direction in the second area so that the first angle θ1 formed between the first direction and the second direction is more than 0° and is equal to or less than 90°. The third portion d3 is formed in the third direction in the second area so that the second angle θ2 formed between the first direction and the third direction is less than 0° and is equal to or more than −90°. The scan electrode comprising the first portion d1, the second portion d2 and the third portion d3 is defined as a type 1.

Further, at least one (for example, the Yb−1 and Yb electrodes) of the remaining electrodes except at least one of the plurality of scan electrodes connected to the driver 600 comprises a first portion d1′, a second portion d2′ and a third portion d3′. The first portion d1′ is formed in the first direction in the first area. The second portion d2′ is formed in the fourth direction in the second area so that the first angle θ1′ formed between the first direction and the fourth direction is less than 0° and is equal to or more than −90°. The third portion d3′ is formed in the fifth direction in the second area so that the second angle θ2′ formed between the first direction and the fifth direction is more than 0° and is equal to or less than 90°. The scan electrode comprising the first portion d1′, the second portion d2′ and the third portion d3′ is defined as a type 2.

In FIG. 6a, the scan electrodes Y of the type 1 and the type 2 are connected to the driver 600.

As illustrated in FIG. 6b, the plurality of scan electrodes connected to a driver 610 do not comprise the scan electrodes of the type 2 (for example, such as the Yb−1 and Yb electrodes in FIG. 6a). For example, the Y1 and Y2 electrodes are the type 1, and the Yb electrode does not bend and has a straight-line shape.

As illustrated in FIG. 6c, the plurality of scan electrodes connected to a driver 620 has a type illustrated in FIG. 6b. The plurality of scan electrodes connected to a driver 630 do not comprise the scan electrodes of the type 1 (for example, such as the Y1 and Y2 electrodes in FIG. 6a). For example, the Ya+1 electrode does not bend and has a straight-line shape, and the Yb−1 and Yb electrodes are the type 2.

As described above, the electrodes may be disposed in the various forms depending on the driver.

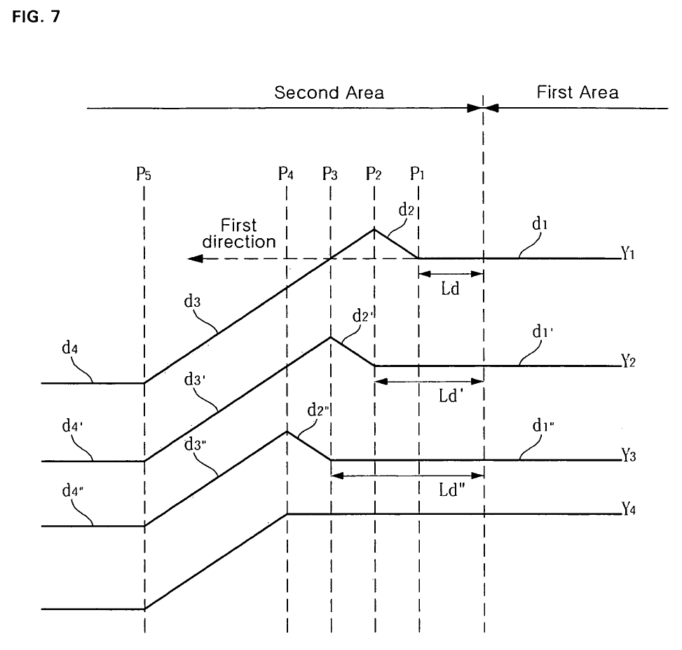

FIG. 7 illustrates the structure of the electrode at different bending points.

Below, the explanation will be given of an example of the scan electrode Y of the plurality of electrodes of the plasma display panel in FIG. 7.

As illustrated in FIG. 7, the length of a first portion formed on the second area of at least one of the plurality of electrodes may be different from the length of a first portion formed on the second area of at least one of the remaining electrodes except at least one of the plurality of electrodes.

More specifically, the Y1, Y2, Y3 and Y4 electrodes each comprise a first portion formed in the first direction, a second portion formed in the second direction, a third portion formed in the third direction, and a fourth portion formed in the first direction.

A first portion d1 of the Y1 electrode is extended to a point P1 of the second area, a second portion d2 is extended from the point P1 to a point P2, a third portion d3 is extended from the point P2, and a fourth portion d4 follows the third portion d3.

The length of the first portion d1 of f the Y1 electrode in the second area is equal to Ld1.

A first portion d1′ of the Y2 electrode is extended to the point P2 of the second area, a second portion d2′ is extended from the point P2 to the point P3, a third portion d3′ is extended from the point P3, and a fourth portion d4′ follows the third portion d3′.

The length of the first portion d1′ of f the Y2 electrode in the second area is equal to Ld1′.

In the same way as the Y1 and Y2 electrodes, the length of the first portion d1″ of f the Y3 electrode in the second area is equal to Ld1″.

When the length of the first portion formed on the second area of at least one of the plurality of electrodes is different from the length of the first portion formed on the second area of at least one of the remaining electrodes except at least one of the plurality of electrodes, a distance between the scan electrodes is sufficiently secured such that the electrical short-circuit between the scan electrodes is efficiently prevented.

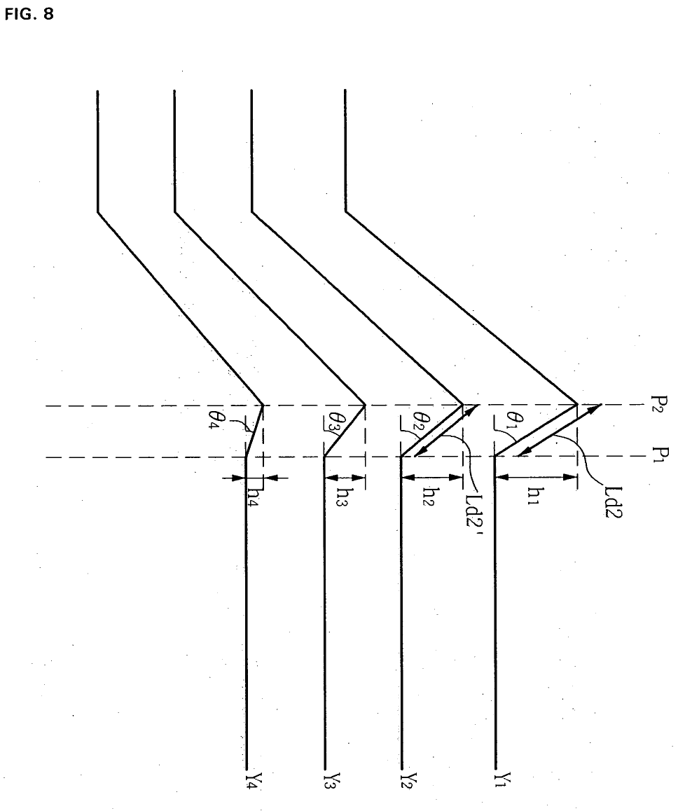

FIG. 8 illustrates the structure of electrodes in which the length of a second portion and a first angle of an electrode are different from the length of a second portion and a first angle of another electrode.

Below, the explanation will be given of an example of the scan electrode Y of the plurality of electrodes of the plasma display panel in FIG. 8.

As illustrated in FIG. 8, the first angle of at least one of the plurality of electrodes may be different from the first angle of at least one of the remaining electrodes except at least one of the plurality of electrodes. The length of the second portion of at least one of the plurality of electrodes may be different from the length of the second portion of at least one of the remaining electrodes except at least one of the plurality of electrodes.

For example, the second portion of the Y1 electrode is extended from the point P1 to the point P2 in the second direction and the first angle between the first direction and the second direction of the Y1 electrode is equal to Q1. A height and a length of the second portion of the Y1 electrode are equal to h1 and Ld2, respectively. The first angle between the first direction and the second direction of the Y2 electrode is equal to Q2 different from Q1 the first angle Q1 of the Y1 electrode. A height and a length of the second portion of the Y2 electrode are equal to h2 and Ld2′ different from the height h1 and the length Ld2 of the second portion of the Y1 electrode, respectively.

In the same was as the Y1 and Y2 electrodes, the length of the second portion and the first angle of each of the Y3 and Y4 electrodes may be different from the length of the second portion and the first angle of the Y1 electrode.

Since the length of the second portion and the first angle of at least one of the plurality of electrodes are different from the length of the second portion and the first angle of at least one of the remaining electrodes except at least one of the plurality of electrodes, a distance between the plurality of electrodes is sufficiently secured such that the electrical short-circuit between the electrodes is efficiently prevented.

The explanation was given of an example where the first angle is more than 0° and is equal to or less than 90° in FIG. 8. However, the first angle may be less than 0° and may be equal to or more than −90°.

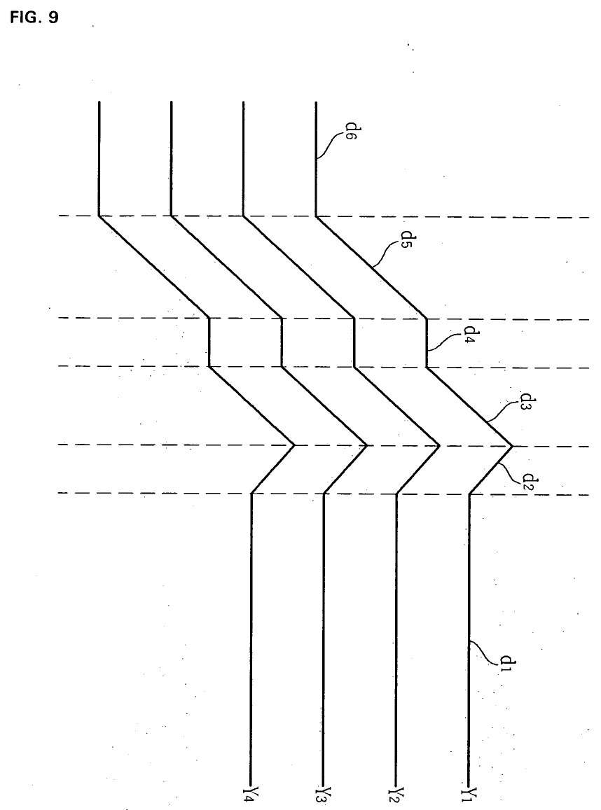

FIG. 9 illustrates the structure of the electrode further comprising another portion.

Below, the explanation will be given of an example of the scan electrode Y of the plurality of electrodes of the plasma display panel in FIG. 9.

As illustrated in FIG. 9, at least one of the plurality of electrodes comprises a fifth portion d5 and a sixth portion d6 other than the first portion d1, the second portion d2, the third portion d3 and the fourth portion d4. Accordingly, a distance between the plurality of electrodes is more sufficiently secured such that the electrical short-circuit between the electrodes is more efficiently prevented.

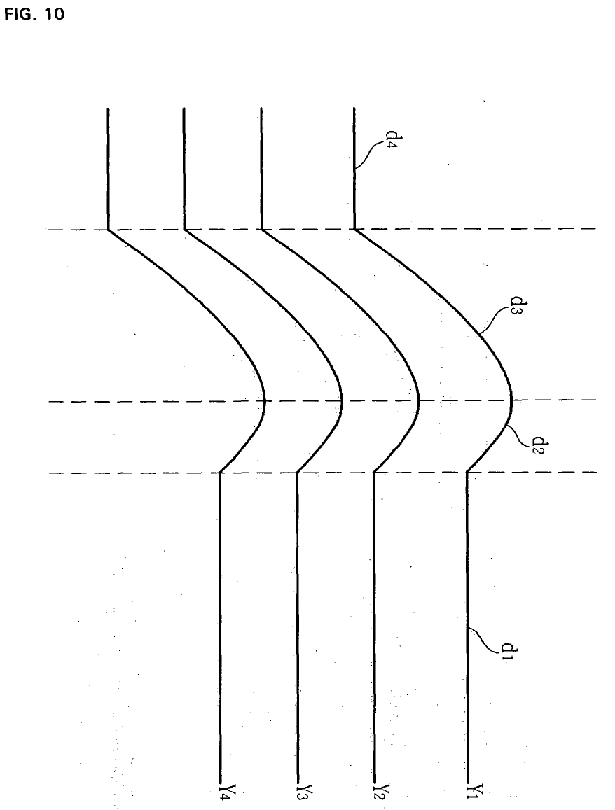

FIG. 10 illustrates the structure of the electrode formed in a different direction.

Below, the explanation will be given of an example of the scan electrode Y of the plurality of electrodes of the plasma display panel in FIG. 10.

As illustrated in FIG. 10, the second portion d2 and the second portion d3 of each of the plurality of scan electrodes Y may be formed in the form of a soft curve.

As described above, the second portion d2 and the second portion d3 of at least one of the plurality of electrodes may be formed in the form of not a straight line but a soft curve.

It is preferable that the two scan electrodes are successively disposed or the two sustain electrodes are successively disposed. Further, it is preferable that the two scan electrodes and the two sustain electrodes are successively disposed.

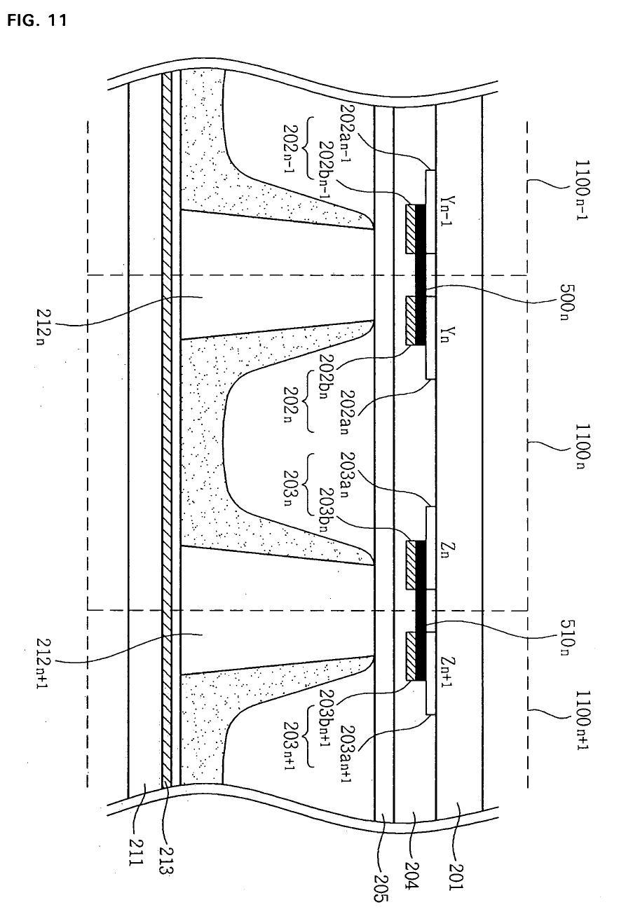

FIG. 11 illustrates the structure in which a plurality of pairs of scan electrodes and a plurality of pairs of sustain electrodes are successively disposed.

The plurality of electrodes may comprise a plurality of pairs of electrodes. A distance between the electrodes in each electrode pair may be less than a distance between each of the pairs of electrodes.

For example, the plurality of electrodes may comprise a plurality of pairs of scan electrodes (Yn−1 and Yn) and a plurality of pairs of sustain electrodes (Zn and Zn+1).

A distance between the scan electrodes Yn−1 and Yn in the scan electrode pair or a distance between the sustain electrodes Zn and Zn+1 in the sustain electrode pair may be less than a distance between the scan electrode pair and the sustain electrode pair.

The distance between the scan electrode pair and the sustain electrode pair is a distance between the scan electrode Yn and the sustain electrode Zn.

More specifically, scan electrode lines 202n−1 and 202n intersecting with an address electrode line are successively disposed in parallel to a transverse barrier rib 212n, and is adjacent to each other. Sustain electrode lines 203n and 203n+1 intersecting with the address electrode line are successively disposed in parallel to a transverse barrier rib 212n+1, and is adjacent to each other.

Reference numerals 1100n−1, 1100n and 1100n+1 indicate a discharge cell, respectively.

In other words, the disposition order of the scan electrode and the disposition order of the sustain electrode are reverse to each other inside the two discharge cells 1100n−1 and 1100n.

As illustrated in FIG. 11, a black layer may be formed between the scan electrode pair Yn−1 and Yn and between the sustain electrode pair Zn and Zn+1 in the first area.

For example, a black layer 500n is formed between the scan electrode pair Yn−1 and Yn and a black layer 510n is formed between the sustain electrode pair Zn and Zn+1.

More specifically, the black layer 500n is formed between first electrodes 202an−1 and 202an and second electrodes 202bn−1 and 202bn of the two scan electrodes Yn−1 and Yn to cover the second electrodes 202bn−1 and 202bn. The black layer 510n is formed between first electrodes 203an and 203an+1 and second electrodes 203bn and 203bn+1 of the two sustain electrodes Zn and Zn+1 to cover the second electrodes 203bn and 203bn+1.

Since the black layer is formed to cover the second electrode, the black layer prevents reflection of external light caused by the second electrode and reflection of external light caused by the barrier rib, thereby further improving contrast.

The black layers 500n and 510n of FIG. 11 may be formed of the same material as a material of the black layers 500 and 510 of FIG. 5. Further, the black layers 500n and 510n of FIG. 11 may be formed of a material different from a material of the black layers 500 and 510 of FIG. 5.

When the scan electrode pair and the sustain electrode pair are formed on the substrate as illustrated in FIG. 11, the disposition of the electrodes in the first area and the second area of the substrate may vary.

FIGS. 12a and 12b illustrate a black layer and the structure in which the scan electrode pair and the sustain electrode pair are formed in a first area and a second area of a substrate.

As illustrated in FIG. 12a, on the substrate comprising the first area where an image is displayed and the second area where an image is not displayed, the plurality of electrodes are formed.

The plurality of electrodes comprise a plurality of pairs of electrodes. A distance between the electrodes in each electrode pair is less than a distance between each of the pairs of electrodes.

For example, the scan electrodes Yn−1 and Yn are formed adjacent to each other in pairs and the sustain electrodes Zn and Zn+1 are formed adjacent to each other in pairs.

The black layer 500n is formed between the adjacent scan electrodes Yn−1 and Yn in the first area and a portion of the second area, and the black layer 510n is formed between the adjacent sustain electrodes Zn and Zn+1 in the first area and a portion of the second area.

In such a case, at least scan electrode pair Yn−1 and Yn each bend at a first bending point P1 and a second bending point P2 in the second area. A distance W_{BP1} between the first bending points P1 of the scan electrode pair Yn−1 and Yn in the second area is substantially equal to a distance W_{Y} between the scan electrode pair Yn−1 and Yn in the first area. A distance W_{BP2} between the second bending points P2 of the scan electrode pair Yn−1 and Yn in the second area is different from the distance W_{Y} between the scan electrode pair Yn−1 and Yn in the first area.

The distance W_{BP2} may be more than the distance W_{Y}.

Accordingly, the distance between the electrodes can relatively widen in the second area where the image is not displayed, and thus preventing the electrical short-circuit between the electrodes.

Further, as illustrated in FIG. 12b, the scan electrode pair Yn−1 and Yn each bend at a third bending point P3 in the second area. A distance W_{BP3} between the third bending points P3 of the scan electrode pair Yn−1 and Yn in the second area may be more than the distance W_{Y} between the scan electrode pair Yn−1 and Yn in the first area.

Accordingly, the distance between the electrodes can relatively widen in the second area where the image is not displayed, and thus preventing the electrical short-circuit between the electrodes.

The plurality of electrodes formed in the first and second areas may comprise at least one a transparent electrode with electrical conductivity or an opaque electrode with electrical conductivity.

The scan electrode pair Yn−1 and Yn, as illustrated in FIG. 12a, each comprise first bent portions d2_Yn−1 and d2_Yn and second bent portions d3_Yn−1 and d3_Yn.

A distance W_{B1} between the first bent portions d2_Yn−1 and d2_Yn gradually increases, and a distance W_{B2} between the second bent portions d3_Yn−1 and d3_Yn is substantially constant or gradually decreases.

Further, a distance W_{B2}′ between second bent portions d3_Yn+1 and d3_Yn+2 of scan electrodes Yn+1 and Yn+2 may increase.

The scan electrode pair Yn−1 and Yn, as illustrated in FIG. 12b, each may comprise third bent portions d4_Yn−1 and d4_Yn. A distance between the third bent portions d4_Yn−1 and d4_Yn may be substantially constant.

Accordingly, it is easy to connect the electrode lines of the driver to the electrode lines of the plasma display panel.

The distance W_{B2} between the second bent portions d3_Yn−1 and d3_Yn of the scan electrode pair Yn−1 and Yn in the second area may be more than the distance W_{Y} between the scan electrode pair Yn−1 and Yn in the first area

Accordingly, the distance between the electrodes can relatively widen in the second area, thereby preventing the electrical short-circuit between the electrodes.

A ratio of the distance W_{Y} between the adjacent electrodes in the first area to the distance W_{B2} between the second bent portions of the adjacent electrodes in the second area ranges from 1:3 to 1:8.

When the ratio of the distance W_{Y} to the distance W_{B2} is equal to or more than 1:3, the distance between the second bent portions is sufficiently secured, thereby preventing the electrical short-circuit between the electrodes.

When the ratio of the distance W_{Y} to the distance W_{B2} is equal to or less than 1:8, the distance between the second bent portions is sufficiently secured, thereby preventing the electrical short-circuit between the electrodes. Further, it is easy to connect the electrode lines of the driver to the electrode lines of the plasma display panel.

A ratio of a section width of at least one of the plurality of electrodes in the first area to a section width of a first bent portion of at least one electrode may range from 1:1.5 to 1:2.5.

For example, a ratio of a section width Wd1 of the scan electrode Yn to a section width Wd2 of the first bent portion d2_Yn of the scan electrode Yn may range from 1:1.5 to 1:2.5.

When the ratio of the section width Wd1 to the section width Wd2 is equal to or more than 1:1.5, the width of the scan electrode Yn in the second area is more than the width of the scan electrode Yn in the first area, thereby properly maintaining the electrical conductivity of the scan electrode Yn in the second area.

When the ratio of the section width Wd1 to the section width Wd2 is equal to or less than 1:2.5, the distance between the electrodes in the second area is maintained properly.

Further, a ratio of a section width of at least one of the plurality of electrodes in the first area to a section width of a second bent portion of at least one electrode may range from 1:1.5 to 1:2.5.

For example, a ratio of the section width Wd1 of the scan electrode Yn to a section width Wd3 of the second bent portion d3_Yn of the scan electrode Yn may range from 1:1.5 to 1:2.5.

When the plurality of electrodes are formed as illustrated in FIGS. 12a and 12b, the total length of the electrode is lengthen such that total inductance of the electrode may increases.

However, an increase in the total inductance may reduce driving efficiency. To prevent a reduction in the driving efficiency, at lest one of the plurality of electrodes formed in the first area of the plasma display panel may comprise a projecting portion projecting in the center of the discharge cell inside the discharge cell.

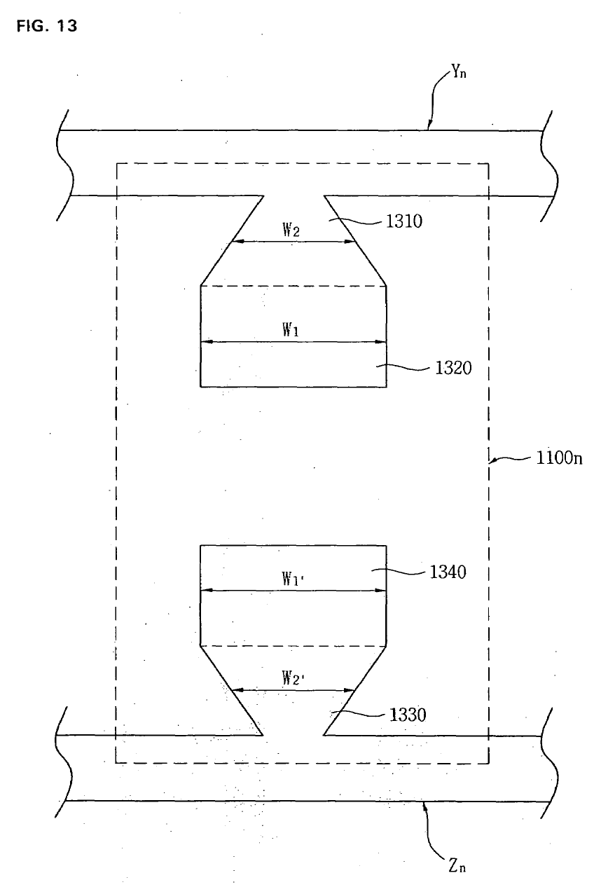

The projecting portion will be described in detail with reference to FIG. 13.

FIG. 13 illustrates the structure of the electrodes in a first area of the substrate of the plasma display panel.

As illustrated in FIG. 13, at lest one of the plurality of electrodes formed in the first area of the substrate of the plasma display panel may further comprise a projecting portion projecting toward the center of the discharge cell inside the discharge cell.

The projecting portion comprises a body part and a head part. A section width of the body part is equal to a first width, and a section width of the head part is equal to a second width less than the first width.

More specifically, the scan electrode Yn and the sustain electrode Zn each further comprise projecting portions comprising head parts 1320 and 1340 and body parts 1310 and 1330.

First widths W₁, W₁′ of the head parts 1320 and 1340 is more than second widths W₂, W₂′ of the body parts 1310 and 1330.

The structure of each of the scan electrode Yn and the sustain electrode Zn is the same as the structure of each of the scan electrode and the sustain electrode in the FIG. 11 except the projecting portion. Accordingly, the scan electrode Yn and the sustain electrode Zn of FIG. 13 each comprise first electrodes 202an and 203an, second electrodes 202bn and 203bn, and black layers 500n, 510n formed between the first electrodes 202an and 203an and the second electrodes 202bn and 203bn.

The projecting portion may be formed of the same material as a material of the first electrodes 202an and 203an. The first electrodes 202an and 203an of the scan electrode Yn and the sustain electrode Zn may project toward the center of a discharge cell 1100n.

It is preferable that the discharge cell 1100n, as illustrated in FIG. 2a, is partitioned by stripe type or well type barrier ribs (not shown).

When forming the projecting portion toward the center of the discharge cell 1100n, a firing voltage of a sustain discharge generated by the scan electrode Yn and the sustain electrode Zn is lowered and the driving efficiency increases.

At least one of the first widths W₁ and W₁′ or the second widths W₂ and W₂′ of the projecting portion may gradually increase.

For example, as illustrated in FIG. 13, as the body parts 1310 and 1330 of the projecting portion go into the center of the discharge cell 1100n within the discharge cell 1100n, the second widths W₂ and W₂′ of the projecting portion gradually increase and the first widths W₁ and W₁′ of the projecting portion is substantially constant.

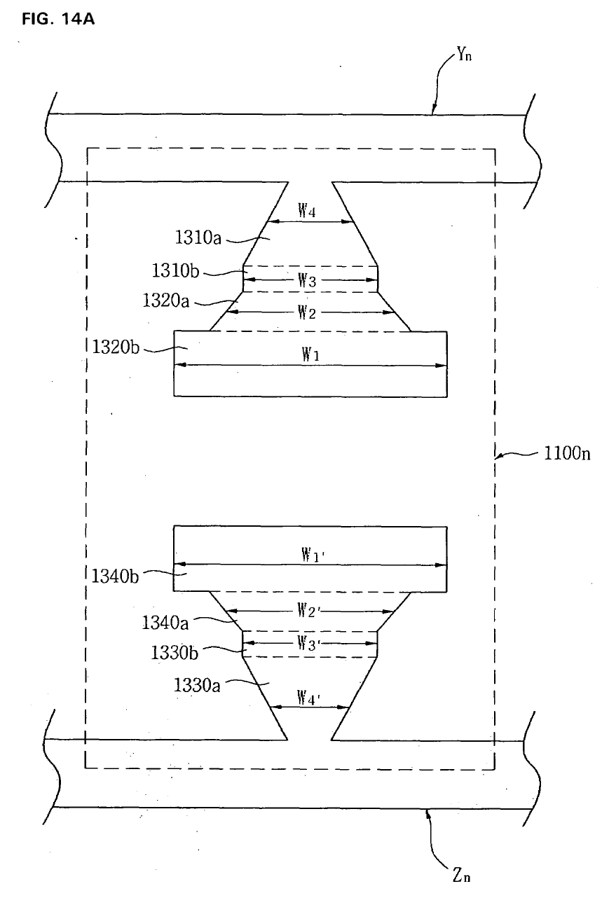

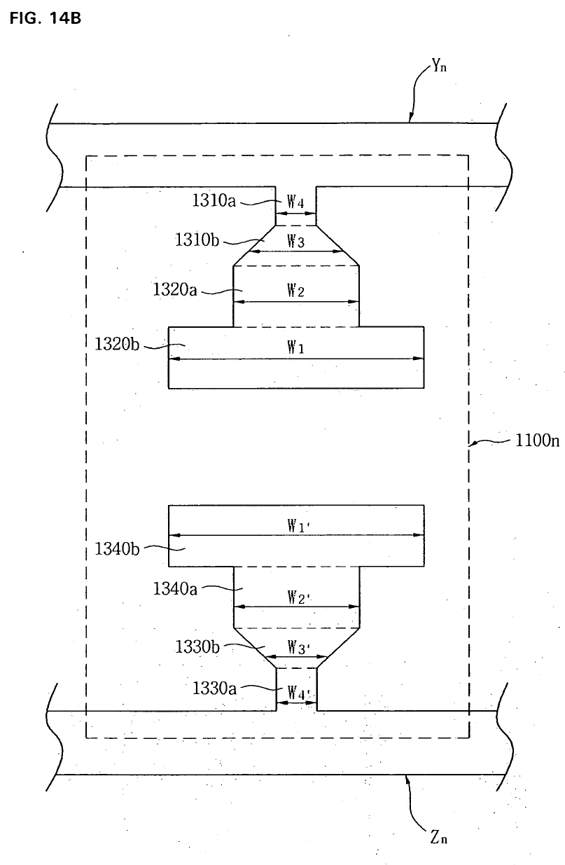

FIGS. 14a and 14b illustrate another structure of a projecting portion.

As illustrated in FIGS. 14a and 14b, the head part of the projecting portion comprises first head parts 1320a and 1340a connected to the body part, and second head parts 1320b and 1340b connected to the first head parts 1320a and 1340a. The body part of the projecting portion comprises first body parts 1310a and 1330a connected to the scan electrode Yn and the sustain electrode Zn formed in the first area, and second body parts 1310b and 1330b connected to the head parts 1310a and 1330a.

Section widths W₁ and W₁′ of the second head parts 1320b and 1340b may be more than section widths W₂ and W₂′ of the first head parts 1320a and 1340a. Section widths W₃ and W₃′ of the second body parts 1310b and 1330b may be more than section widths W₄ and W₄′ of the first body parts 1310a and 1330a.

At least one of the first head parts 1320a and 1340a, the second head parts 1320b and 1340b, the first body parts 1310a and 1330a or the second body parts 1310b and 1330b has the gradually increasing width as it goes into the center of the discharge cell 1100n within the discharge cell 1100n.

For example, as illustrated in FIG. 14a, the section widths W₂ and W₂′ of the first head parts 1320a and 1340a and the section widths W₄ and W4′ of the first body parts 1310a and 1330a gradually increase as they goes into the center of the discharge cell 1100n within the discharge cell 1100n.

Further, as illustrated in FIG. 14b, only the second body parts 1310b and 1330b may have the gradually increasing section widths W₃ and W₃′.

When applying the above-described electrode structure to the plasma display panel in which a Pb content of at least one of the components of the plasma display panel such as the barrier rib, the phosphor layer, the dielectric layer, the protective layer is equal to or less than 1,000 PPM, more effective result is obtained.

When the electrodes of the above-described structure are formed in the first area and the second area of the substrate and the Pb content of the plasma display panel is within the above range, a driving signal supplied to the plasma display panel may vary appropriately.

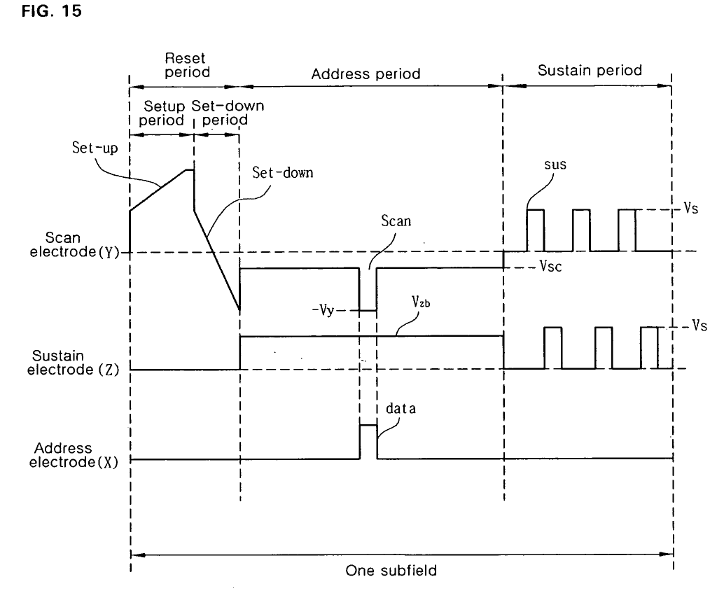

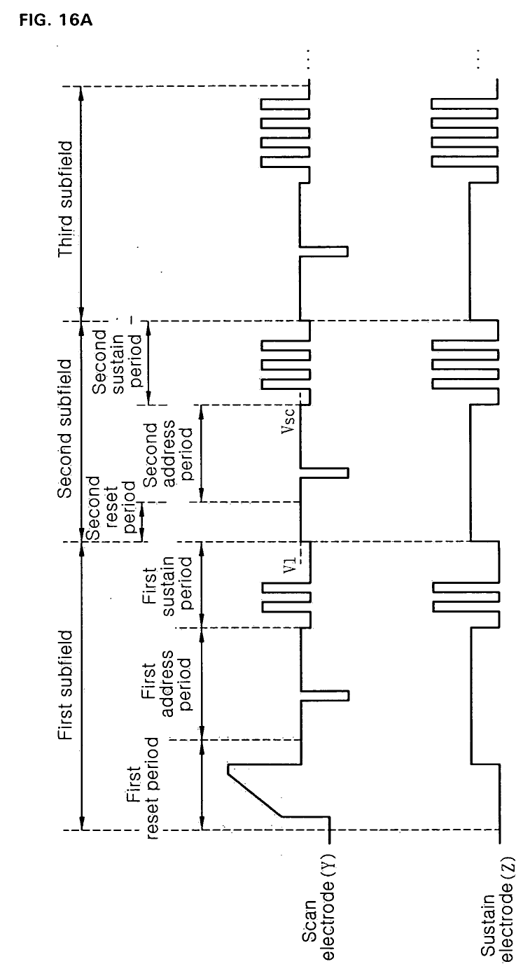

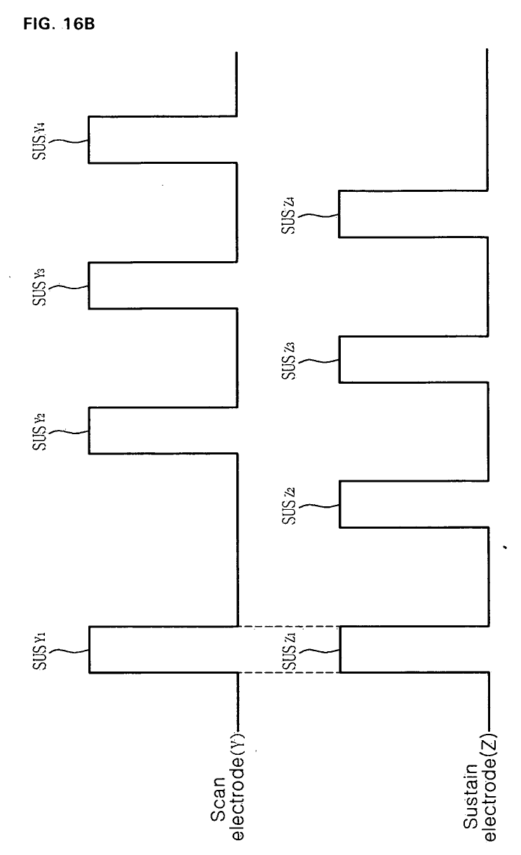

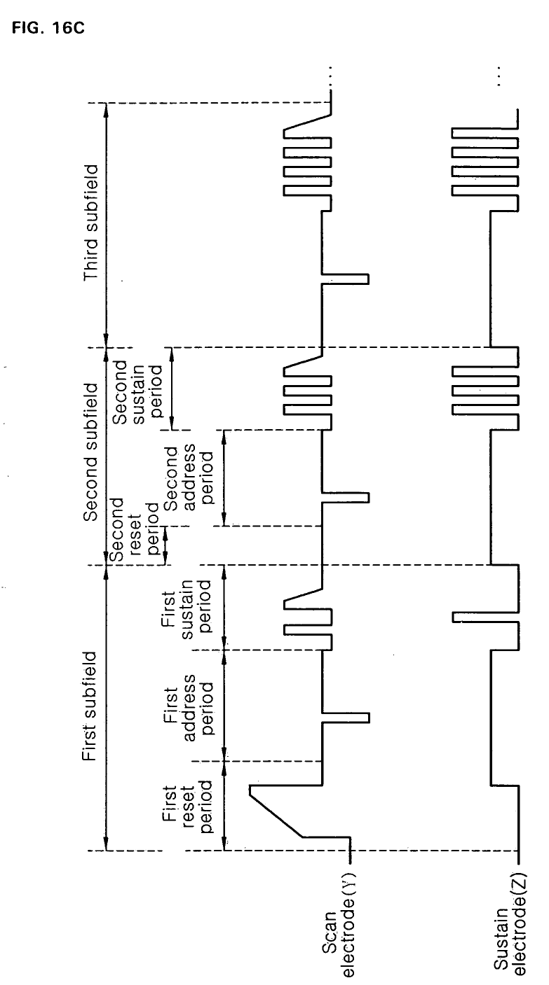

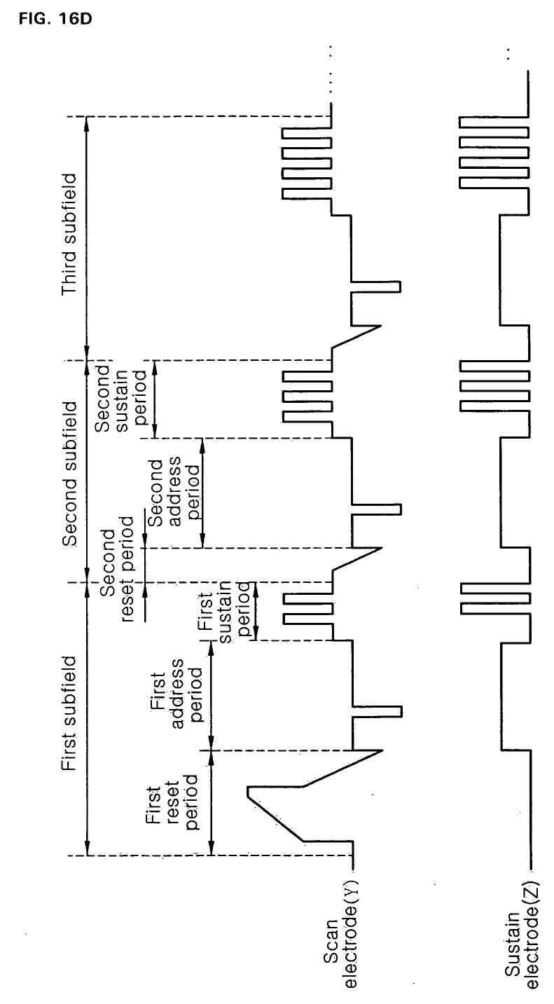

The following is a detailed description of a driving signal supplied to the plasma display panel, with reference to FIG. 15 and FIGS. 16a to 16d.

FIG. 15 illustrates an example of a driving signal supplied to the plasma display panel.

As illustrated in FIG. 15, during a setup period of a reset period, a setup signal (Set-Up) with a gradually rising voltage may be simultaneously supplied to all the scan electrodes Y.

The setup signal (Set-Up) generates a weak dark discharge (i.e., a setup discharge) inside the discharge cell. This results in a predetermined amount of wall charges being accumulated inside the discharge cell.

During a set-down period of the reset period, a set-down signal (Set down) gradually falling from a positive voltage lower than a peak voltage of the setup signal (Set-Up) may be supplied to the scan electrode Y.

As a result, a weak erase discharge (i.e., a set-down discharge) occurs within the discharge cell, thereby erasing a portion of the wall charges accumulated inside the discharge cell by the setup discharge. The remaining wall charges are uniform inside the discharge cells to the extent that the address discharge can be stably performed.

Although the explanation was given of an example where a reset signal includes the setup signal and the set-down signal supplied during the reset period in FIG. 15, another signal may be supplied prior to the reset period

For example, during a pre-reset period prior to the reset period, another set-down signal with a gradually falling voltage may be supplied to the scan electrode Y and a signal maintained at a positive voltage may be supplied to the sustain electrode Z.

During an address period which follows the reset period including the setup period and the set-down period, a scan reference voltage Vsc and a scan signal (Scan) falling from the scan reference voltage Vsc may be supplied to the scan electrode Y.

The scan signal (Scan) may fall up to a negative scan voltage −Vy.

A scan driver (not shown) supplies the scan signal (Scan) to the scan electrode Y.

When supplying the scan signal (Scan) to the scan electrode Y, a data signal (data) synchronized with the scan signal (Scan) may be supplied to the address electrode X.

A data driver (not shown) supplies the data signal (data) to the address electrode X.

Further, during the address period, a sustain bias voltage Vzb may be supplied to the sustain electrode Z to prevent the generation of an erroneous discharge caused by the interference of the sustain electrode Z.

A sustain driver (not shown) supplies the sustain bias voltage Vzb to the sustain electrode Z.

As the voltage difference between the scan signal (Scan) and the data signal (data) is added to the wall voltage generated during the reset period, an address discharge occurs within the discharge cells to which the data signal (data) is supplied.

Wall charges are formed inside the discharge cell selected by performing the address discharge such that when a sustain voltage Vs is applied a discharge occurs.

During a sustain period which follows the address period, a sustain signal (SUS) is supplied to the scan electrode Y or the sustain electrode Z.

At least one of the scan driver or the sustain driver supplies the sustain signal (SUS) to the scan electrode Y or the sustain electrode Z.

As the wall voltage within the discharge cell selected by performing the address discharge is added to the sustain voltage Vs of the sustain signal (SUS), every time the sustain signal (SUS) is supplied, a sustain discharge, i.e., a display discharge is generated between the scan electrode Y and the sustain electrode Z. Accordingly, an image is displayed on the plasma display panel.

Although the explanation was given of an example where the sustain signal (SUS) is alternately supplied to the scan electrode Y and the sustain electrode Z, Another type of sustain signal may be supplied to either the scan electrode Y or the sustain electrode Z.

For example, Another type of sustain signal may be supplied to only the scan electrode Y.

More specifically, wherein another type of sustain signal comprising a positive sustain voltage +Vs and a negative sustain voltage −Vs may be supplied to one of the scan electrode Y and the sustain electrode Z, and the ground level voltage may be supplied to the remaining electrode.

When a Pb content, based on all components of the plasma display panel thus driven is equal to or less than 1,000 PPM, there is a great likelihood that a driving characteristic is unstable.

More specifically, since Pb has a relatively low melting point and is easy to mold, Pb has been widely used to manufacture the plasma display panel. Further, Pb of a metal material has a relatively low capacitance.

Accordingly, when the plasma display panel includes a relatively large amount of Pb, a total capacitance of the plasma display panel is relatively low.

Since the large amount of Pb adversely affects the body, the Pb content of the plasma display panel is limited to be equal to or less than 1,000 PPM.

When the Pb content of the plasma display panel is equal to or less than 1,000 PPM, the capacitance of the plasma display panel is relatively high.

However, when the capacitance of the plasma display panel is high, the driving characteristic is unstable. This results in reducing the definition of an image.

To prevent a reduction in the definition of the image, a first reset signal for initializing a discharge cell is supplied to the plurality of electrodes during a first reset period of a first subfield. Then, a second reset signal including at least one of a setup signal with a gradually rising voltage, a set-down signal with a gradually falling voltage or a bias signal maintained at a first voltage is supplied to the plurality of electrodes during a second reset period of a second subfield.

This will be described later with reference to FIGS. 16a to 16d.

One frame may include the first subfield and the second subfield. The first subfield may be at least one of a plurality of subfields of one frame. The second subfield may be at least one of the remaining subfields except the first subfield of the plurality of subfields of one frame.

In other words, the unstable driving characteristic caused by an increase in the capacitance is solved by supplying different signals during each of the reset periods of the subfields.

FIGS. 16a to 16d illustrate a method for supplying different reset signals in subfields.

As illustrated in FIGS. 16a to 16d, a second reset signal supplied to the scan electrode Y during a second reset period of a second subfield may comprise either a setup signal or a set-down signal. Alternately, a second reset signal may be a bias signal maintained at a first voltage.

For one example, referring to FIG. 16a, a first reset signal comprising a first setup signal is supplied to the scan electrode Y during a first reset period of a first subfield of a plurality of subfields of one frame, and the bias signal of the second reset signal maintained at the first voltage is supplied to the scan electrode Y during the second reset period of the second subfield.

The first voltage V1 may be substantially equal to the scan reference voltage Vsc supplied to the scan electrode Y during a second address period of the second subfield.

It is preferable that the first subfield in which the first reset signal is supplied is a subfield having a lowest gray level weight of the plurality of subfields of the frame.

Although the explanation was given of an example where the reset signal is supplied in only the first subfield in FIG. 16a, the reset signal may be supplied in the first subfield and the second subfield, respectively, and the bias signal of the second reset signal maintained at the first voltage may be supplied in the remaining subfields except the first and second subfields.

When the reset signal is supplied only in a given subfield of the plurality of subfields of the frame and the bias signal of the reset signal is supplied in the remaining subfields, the sustain signal may be set in a type of FIG. 16b that illustrates a detail of a second sustain period of the second subfield of FIG. 16a.

As illustrated in FIG. 16b, a plurality of sustain signals (SUSY1 to SUSY4 and SUSZ1 to SUSZ4) may be supplied to the scan electrode Y and the sustain electrode Z during the second sustain period of the second subfield. The first sustain signal (SUSY1) of the plurality of second sustain signals (SUSY1 to SUSY4) supplied to the scan electrode Y may mostly overlap the first sustain signal (SUSZ1) of the plurality of sustain signals (SUSZ1 to SUSZ4) supplied to the sustain electrode Z.

Thus, when supplying the first sustain signals (SUSY1 and SUSZ1), the sustain discharge is not generated, or though the sustain discharge is generated, the sustain discharge is relatively weak in intensity.

The reason why the first sustain signals (SUSY1 and SUSZ1) overlap each other as above is that the possibility of the unstable sustain discharge is great because the reset signal is supplied only in at least one subfield of the plurality of subfields of the frame and the reset signal is not supplied in the remaining subfields.

More specifically, when the reset signal is not supplied such that the wall charges remains in a unstable state within the discharge cell, the direct supplying of the sustain signal having a relatively high voltage generates an excessively strong sustain discharge such that the wall charges remains in a more unstable state within the discharge cell. Further, an excessively weak sustain discharge is generated such that subsequent sustain discharges may be weak in intensity.

Since the first sustain signals (SUSY1 and SUSZ1) overlap each other such that the wall charges remains in a stable state within the discharge cell, the generation of the excessively strong sustain discharge or a reduction in the intensity of the subsequent sustain discharges are prevented.

The second sustain signal is first supplied to the sustain electrode Z. In other words, after the first sustain signals. (SUSY1 and SUSZ1) are supplied, the second sustain signal (SUSZ2) is supplied to the sustain electrode Z and the second sustain signal (SUSY2) is then supplied to the scan electrode Y.

When the second sustain signal (SUSZ2) is supplied to the sustain electrode Z faster than the scan electrode Y, the last-sustain signal (SUSY4 of FIG. 16b) may be supplied to the scan electrode Y.

Thus, various changes are possible that another signal can be supplied to the scan electrode Y between a sustain period of one subfield and an address period of a next subfield.

Referring next to FIG. 16c, unlike FIG. 16a, the first driving signal is supplied in the first subfield, and the second driving signal is supplied in the second subfield. When the second reset signal being the bias signal maintained at the first voltage that is substantially equal to a scan reference voltage is supplied during the second reset period of the second subfield, a falling slope of the last sustain signal of the plurality of sustain signals supplied to the scan electrode Y in the first subfield that is a subfield earlier than the second subfield may be substantially equal to a falling slope of a set-down signal supplied to the scan electrode Y during the set-down period.

The reason why the falling slope of the last sustain signal of the plurality of sustain signals supplied to the scan electrode Y in the subfield SF1 earlier than the second subfield SF2 is substantially equal to the falling slope of the set-down signal is to generate a more stable address discharge during the second address period of the second subfield by appropriately erasing some of wall charges using the last sustain signal among a plurality of sustain signals supplied in the subfield SF1 earlier than the second subfield SF2, because a signal for appropriately erasing some of the wall charges within the discharge cell is not substantially supplied during the second reset period of the second subfield.

A case of FIG. 16c may be changed like FIG. 16b. This is in detail described enough as above and thus, a more description will be omitted.

Referring next to FIG. 16d, the first reset signal including the setup signal and the set-down signal is supplied during the first reset period of the first subfield, and the second reset signal comprising a set-down signal is supplied during the second reset period of the second subfield.

In the subfield in which the reset signal comprising the setup signal is not supplied, only the set-down signal may can supplied and thee wall charges remain in the stable state within the discharge cell.

The second reset signal supplied to the scan electrode Y during the second reset period of the second subfield may comprise either the setup signal or the set-down signal.

A case of FIG. 16d can be changed like FIG. 16b. This is in detail described enough as above and thus, a more description will be omitted.

More various implementations can be provided in addition to several implementations.

For example, in the different subfields, rising slopes of the setup signals may be equal to each other and maximum voltages of the setup signals may be differentiated from each other, or falling slopes of the set-down signals may be equal to each other and the minimum voltages of the set-down signals may be differentiated from each other, thereby changing the durations of the reset periods of the different subfields. Further, the reset signal may be maintained at a predetermined voltage for a relatively long time, thereby changing the durations of the reset periods of the different subfields.

Other implementations are within the scope of the following claims.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel comprising a first substrate, a dielectric layer formed on the first substrate, a protective layer formed on the dielectric layer, a second substrate facing the first substrate, and barrier ribs between the first and second substrates, the plasma display panel comprising:
a first area where an image is displayed and a second area where the image is not displayed; and
a plurality of electrodes formed in the first area and the second area, wherein at least one of the plurality of electrodes has a first bending point and a second bending point in the second area and has a distance between the first bending points being different from a distance between the second bending points in the second area,
wherein the protective layer, the barrier ribs, and the dielectric layer have a Pb content equal to or less than 1,000 PPM (parts per million).

2. The plasma display panel of claim 1, wherein the distance between the second bending points of the at least one of the plurality of electrodes in the second area is longer than the distance between the distance between the at least one of the plurality of electrodes in the first area.

3. The plasma display panel of claim 1, wherein the at least one of plurality of electrodes has a third bending point in the second area.

4. The plasma display panel of claim 1, wherein the plurality of electrodes each comprise transparent electrodes.

5. A plasma display panel comprising a first substrate, a dielectric layer formed on the first substrate, a protective layer formed on the dielectric layer, a second substrate facing the first substrate and barrier ribs between the first and second substrates, the plasma display panel comprising:
a first area where an image is displayed and a second area where the image is not displayed; and
a plurality of electrodes formed in the first area and the second area, wherein at least one of the plurality of electrodes has a first bent portion and a second bent portion in the second area and has a distance between the first bent portions gradually increases, and a distance between the second bent portions is substantially constant or gradually decreases,
wherein the protective layer, the barrier ribs and the dielectric layer have a Pb content being equal to or less than 1,000 PPM.

6. The plasma display panel of claim 5, wherein the at least one of the plurality of electrodes comprises a third bent portion in the second area, and
a distance between the third bent portions is substantially constant.

7. The plasma display panel of claim 5, wherein the distance between the second bent portions in the at least one of the plurality of electrodes is more than a distance between the electrodes in the at least one of the plurality of electrodes in the first area.

8. The plasma display panel of claim 7, wherein a ratio of the distance between the electrodes in the at least one of the plurality of electrodes in the first area to the distance between the second bent portions in the at least one of the plurality of electrodes ranges from 1:3 to 1:8.

9. The plasma display panel of claim 5, wherein a ratio of a section width of the at least one of the plurality of electrodes in the first area to a section width of the first bent portions in the at least one of the plurality of electrodes ranges from 1:1.5 to 1:2.5.

10. The plasma display panel of claim 5, wherein a ratio of a section width of each electrode in the at least one of the plurality of electrodes in the first area to a section width of the second bent portions in the at least one of the plurality of electrodes ranges from 1:1.5 to 1:2.5.

11. A plasma display panel comprising a substrate, a plurality of electrodes formed on the substrate, a protective layer and a dielectric layer,
wherein a Pb content of at least one of the protective layer or the dielectric layer is equal to or less than 1,000 PPM,
the substrate comprises a first area where an image is displayed and a second area where the image is not displayed,
the plurality of electrodes are formed in the first area and the second area,
at least one electrode of the plurality of electrodes comprises a first portion, a second portion and a third portion,
the first portion is formed in the first area and the second area such that the first portion in the first area is formed to extend in a first direction toward the second portion in the second area,
the second portion is formed in the second area in a second direction different from the first direction such that a first angle is formed between the first direction and the second direction and extending in the second direction from the first portion toward the third portion, and
the third portion is formed in the second area in a third direction different from the first direction and the second direction such that a second angle is formed between the first direction and the third direction.

12. The plasma display panel of claim 11, wherein the plurality of electrodes comprise a plurality of pairs of electrodes wherein a distance between the electrodes in each electrode pair is less than a distance between each of the pairs of electrodes, and
the first angle is formed such that a distance between the second portions in the electrode pair gradually increases, and the second angle is formed so that a distance between the third portions in the electrode pair is substantially constant or gradually decreases.

13. The plasma display panel of claim 11, wherein at least one electrode of the plurality of electrodes comprises a fourth portion in the second area, and the fourth portion is formed in a direction substantially equal to the first direction.

14. The plasma display panel of claim 11, wherein at least one electrode of the plurality of electrodes comprises a first electrode in the second area, and
the first electrode is formed between the substrate and a black layer having a width that is substantially equal to or less than a width of the first electrode.

15. The plasma display panel of claim 14, wherein at least one electrode of the plurality of electrodes comprises the first electrode and a second electrode in the second area, and
the black layer is formed between the first electrode and the second electrode, and
a width of the black layer is substantially equal to a width of the second electrode.

16. The plasma display panel of claim 15, wherein the first electrode is formed of a transparent material with the electrical conductivity, and the second electrode is formed of an opaque material with the electrical conductivity.

17. The plasma display panel of claim 11, wherein a length of the first portion in the second area of at least one electrode of the plurality of electrodes is different from a length of a first portion in the second area of at least one electrode of the remaining electrodes except at least one electrode of the plurality of electrodes.

18. The plasma display panel of claim 11, wherein a length of the second portion of at least one electrode of the plurality of electrodes is different from a length of a second portion of at least one electrode of the remaining electrodes except at least one electrode of the plurality of electrodes.

19. The plasma display panel of claim 11, wherein the first angle of at least one electrode of the plurality of electrodes is different from a first angle of at least one electrode of the remaining electrodes except at least one electrode of the plurality of electrodes.

20. The plasma display panel of claim 11, wherein the plurality of electrodes each comprise a plurality of scan electrode pairs and a plurality of sustain electrode pairs disposed in parallel to each other, and
a distance between the electrodes in each scan electrode pair and a distance between the electrodes in each sustain electrode pair are less than a distance between the scan electrode pair and the sustain electrode pair.
